(19) United States
(12) Patent Application Publication
(10) Pub. No.: US 2022/0292431 A1
(43) Pub. Date: Sep. 15, 2022

(54) RESOLUTION SELECTION AND DEPLOYMENT

(71) Applicant: Avaya Management L.P., Durham, NC (US)

(72) Inventors: Harsimran Jeet Singh, Pune (IN); Jibin George, Pune (IN); Sandeep Goynar, Pune (IN); Valentine C. Matula, Granville, OH (US)

(21) Appl. No.: 17/199,642

(22) Filed: Mar. 12, 2021

(51) Int. Cl. G06Q 10/06

(52) U.S. Cl. CPC G06Q 10/063112; G06Q 10/06312; G06Q 10/06314; G06Q 10/063118

(57) ABSTRACT

Systems and methods are provided to select and implement a resolution path, of a number of resolution paths, to resolve a work item prior to the expiration of a time constraint. The expiration of the time constraint, absent the resolution, results in a duplication of loads on resources that are necessary to re-establish and maintain the communication to obtain the resolution during a subsequent communication.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for routing a communication and particularly to selecting operations of a communication and a node to engage in the communication based on a time constraint.

### BACKGROUND

Contact centers strive to make sure that customer calls are answered promptly by an agent, the agent provides efficient and effective services to the customer, and the agent's time is well utilized to provide the services. Customer time is also of great importance, while no one would choose to wait on hold, customers that have other commitments may tie-up computing and networking resources only to abandon a call before resolution is achieved. As a result, customers often need to call again and similarly tie-up computing and networking resources as they try again to get resolution.

Calls that are not immediately answered may be placed in queue to wait for the next available agent. In some circumstances, the customer is provided with an estimated wait-time or their position within the queue. The estimated wait time is based on historical data which may or may not be accurate and with no knowledge of the size of the agent pool or how long each preceding call is likely to take, customers can only guess at how long it will take for their call to be answered by an agent.

### SUMMARY

On the customer side, a call may have a limited amount of time. For example, a traveler who needs to adjust a flight reservation due to a delay on a prior leg may have only a short time to make a call before needed to board their next flight. In such a case, the prior art of contact centers assumes every customer has the time required to wait for the agent, although they also know that a certain number of customers will abandon a call while in-queue or while engaged with an agent but before obtaining resolution to the issue that motivated the call. As a result, the agents address the customer calls in the same manner without considering the customer's time constraints.

Without considering the customer's time constraints, prior art contact centers may cause the customer to drop the call before being connected to an agent or abruptly drop the call while engaged with an agent. For example, an agent may be placing the customer on hold a number of times in order to look for a different agent to transfer the call to or to look though issues and resolutions in a knowledge base at a leisurely pace. The customer may get irritated if progress towards a resolution appears too slow to maintain the call and drop the call. In many cases, the customer will call again with exactly the same problem and restart the process all over.

An advancement to the prior art of contact centers is provided herein such that systems are aware of time constraints of customers and agents are informed accordingly. As a result, the handling of a customer, even if the customer's position in a wait queue is unaffected, may be condensed or otherwise modified to accommodate the time frame for the call. Often, if a complete resolution is not possible, a partial resolution may still result in a subsequent call requiring fewer resources and improve customer satisfaction.

These and other needs are addressed by the various embodiments and configurations of the present invention. The present invention can provide a number of advantages depending on the particular configuration. These and other advantages will be apparent from the disclosure of the invention(s) contained herein.

Contact center resources, such as computing and network resources, may be utilize more efficiently as calls from customers that would otherwise be abandoned before resolution may be processed more compactly in order to obtain resolution or, if not resolved, allow partial progress so the customer does not have to call again and restart the process from scratch. As a result of the efficient use of contact center resources, customers may be provided with improved customer services by obtaining complete resolution or, if not, performing the timely and relevant portions of a call to allow for at least partial resolution or omit the need to restart from scratch if a subsequent call is required.

In one embodiment, a customer is asked whether they have time a time constraint and, if so, the maximum amount of time available. The amount of time available may not have an impact on time in queue and the call routed to agents utilizing the same routing logic utilized for calls that are not subject to a time constraint. To mitigate and disincentivize abuse, a customer's call is routed utilizing the same logic, prioritization, etc., as calls without a time constraint. However, once connected to an agent, the resulting communication may then differ from calls absent the time constraint.

If it is determined that the call cannot be answered or resolved within the timeframe provided by the customer, then the customer may be connected to an automated resources, such as a messaging system or interactive voice response (IVR) to leave a message and schedule a callback. As a benefit, calls that are held in queue, but are known to be unresolvable within the timeframe available, may be terminated quickly and re-initiated at a time where resolution may be obtained, and subsequent calls from customers within the queue are not forced to wait while resources are spent unnecessarily on the prior call that will not result in a resolution and may need to be spent again on a subsequent call in order to obtain the resolution.

In one embodiment, when a customer calls a contact center, they will be prompted for their availability. This may be provided in response to a IVR prompt or automated speech recognition system or an application, such as executing on a mobile telephone, which may then be encoded in a Session Initiation Protocol (SIP) header such as the CUSTOM header in the SIP INVITE messages.

In another embodiment, the time available may be adjusted while in queue or engaged with an agent. For example, if a customer initially stated they have ten minutes of availability, but ended up waiting in the queue for six minutes, the customer may be asked if the time limitation still applies. If the customer opts to remove the time limit, the call may be processed normally. If the time constraint remains, then a controller may format instructions to deliver to the customer based on the remaining time available. The instructions may be selected based on the specific time available (e.g., “instruction 1 if 0-2 minutes,” “instruction 2 if 2-5 minutes,” instruction 3 if 5-10 minutes,” etc.). In a further embodiment, scripting provided to an agent communication device may be revised according to the time available to comprise the relevant content for the particular time. For example, a script may be delivered to instruct the agent to omit searching a knowledge base if the results cannot be obtained in sufficient time.

In another embodiment, if the customer extends the call beyond the initial time period indicated, the customer may be deemed to have consented to remain on the call for more than the initially indicated available time period, wherein the normal processing flow is resumed as if the call were not time-constrained call.

In another embodiment, priority routing may be provided, such as for high-profile customers or customers who pay for prioritized service. For example, caller who states they only have five minutes could be referenced with a customer resource management system to determine the customer is a “platinum” level member. As a result, priority routing or routing to an agent who is known to have an ability to processes the transaction quickly may be selected and the call routed thereto.

Additionally system also can provide the agent with a countdown clock since the customer said he/she has 5 min. If the customer waited 70 seconds in the queue, then the agent has (300−70=230 seconds) left on the time budget. Agent prompts can be used to check the transaction, and warn the agent that they will need approximately ‘N’ seconds, and that is less than the remaining time budget. So, the agent may be informed accordingly, such as to dismiss the warning and proceed to the best of the agent's abilities; ask the customer if more time is available, schedule a callback, etc. If the customer already extended the call beyond the previously indicated limit, or further beyond a previously determined margin (e.g., 10%, 15%, etc.), then the customer may be deemed to be abusing the system and the call reverted to normal handling.

A potential for abuse exists in that a customer may believe they will obtain an advantage by indicating a limited amount of time. One means to prevent such abuse is to maintain existing routing logic for all calls so that calls are not prioritized based on indicated time available. Calls may still be prioritized based on other factors, such as a high priority customer as indicated in a CRM record. Customer may be asked if they are in a hurry or if they wish to receive “full service,” and then routed/queued for an agent that is skilled in either giving fast service or full service. Systems may provide quality monitoring to determine how successful agents were at delivering particular type of service (e.g., fast service or full service) for use in routing future calls.

In one embodiment, systems and methods are provided to tune and control an interaction with a customer based on a time constraint provided by the customer. In one embodiment, a controller unit identifies a resolution path that conforms to the time constraint. Notifications may be provided to ensure pacing with the resolution path. In another embodiment, the content of a script delivered to the agent may be selected or altered in order to confirm with the time constraint. While normal handing (e.g., handling absent a specified time constraint) may seek to balance the gathering and providing of content with building a rapport with the customer, being friendly, cultural norms, etc., such as to ask fully structured sentences, “What city are you leaving from?” However, to provide a more compact transaction to better fit within the time constraints, the content of the script may be revised, such as to comprise the more compact, “Departing city?”

In another embodiment, an artificial intelligence (AI), such as a neural network, may be trained with information regarding a customer or category of customers, such as time of the day, past interactions, choices made for the type of service selected in the past, etc. Additionally or alternatively, the AI may be trained to determine to assess whether the customer is honest and accurate when they ask for fast service. As a further option, feedback survey results may be obtained, as well as call analysis, to train a model to predict what type of service to be provided for the future calls. Once trained, the AI model can assess the situation and predict the type of service which will be preferred by the customer and get a confirmation from the customer. Such a system may be able to select the type of service absent prompting or explicit input from the customer

In one embodiment, a system is disclosed, comprising: a network interface to a network; a processor with machine-readable instructions that when read by the processor cause the processor to perform: accessing a communication comprising a customer device utilized by a customer for communicating with the system via the network; accessing a work item from the customer device that will be resolved during the communication as a prerequisite to successfully closing the work item; obtaining a time constraint, upon the expiration of the time constraint will cause the communication to be terminated; selecting an agent, from a pool of agents, that has a skill associated with expedited resolution of the work item, when the time constraint is less than an estimated time to resolve the work item, and selecting the agent, from the pool of agents, that has a skill associated with full-service resolution of the work item, when the time constraint, is not less than the estimated time to resolve the work item; and routing the communication to include an agent device, utilized by the agent.

In another embodiment, a system is disclosed, comprising: a network interface to a network; a processor with machine-readable instructions that when read by the processor cause the processor to perform: accessing a communication comprising a customer device utilized by a customer for communicating with the system via the network; accessing a work item from the customer device that will be resolved during the communication as a prerequisite to successfully closing the work item; obtaining a time constraint from the customer device that, upon the expiration of the time constraint will cause the communication to be terminated; selecting a resolution path from a set of resolution paths associated with expedited resolution of the work item, when the time constraint is less than an estimated time to resolve the work item, and selecting the resolution path, from the pool of resolution paths, that is associated with full-service resolution of the work item, when the time constraint, is not less than the estimated time to resolve the work item; routing the communication to include an agent device, utilized by an agent; and providing the resolution path to the agent device for execution.

In another embodiment, a method is disclosed, comprising: accessing a communication comprising a customer device utilized by a customer for communicating with the system via a network; accessing a work item from the customer device that will be resolved during the communication as a prerequisite to successfully closing the work item; obtaining a time constraint, upon the expiration of the time constraint will cause the communication to be terminated; selecting an agent, from a pool of agents, that has a skill associated with expedited resolution of the work item, when the time constraint is less than an estimated time to resolve the work item, and selecting the agent, from the pool of agents, that has a skill associated with full-service resolution of the work item, when the time constraint, is not less than the estimated time to resolve the work item; and routing the communication to include an agent device, utilized by the agent.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts resolution paths in accordance with embodiments of the present disclosure;

FIG. 4 depicts a first process in accordance with embodiments of the present disclosure;

FIG. 5 depicts a second process in accordance with embodiments of the present disclosure;

FIG. 6 depicts a third process in accordance with embodiments of the present disclosure;

and

FIG. 7 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

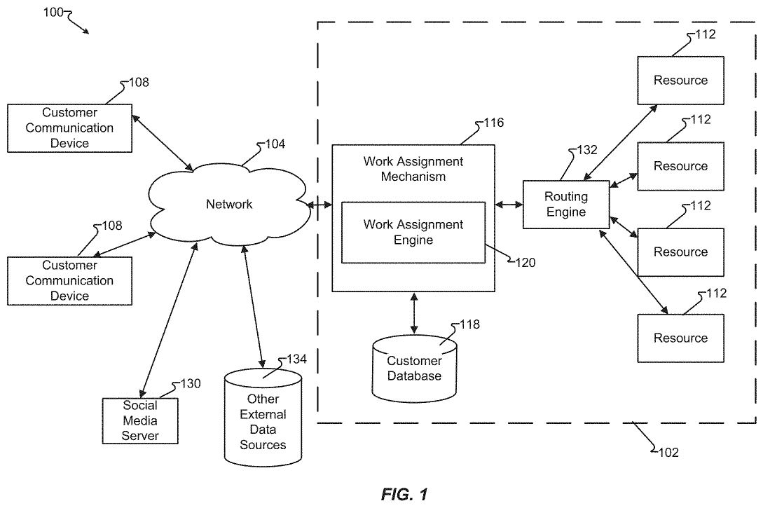

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to customer communication devices. In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the customer communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

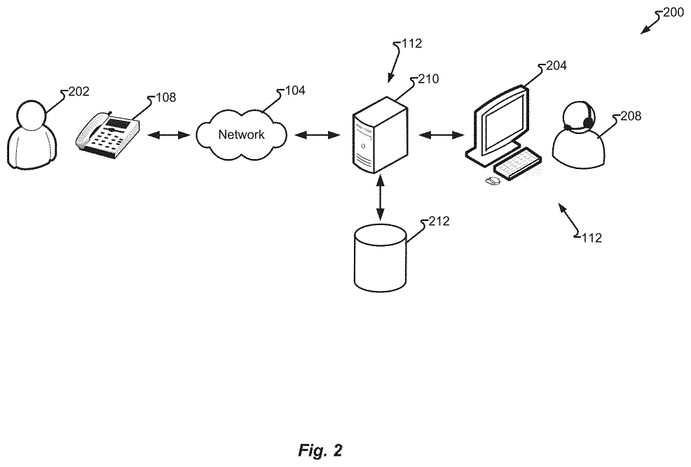

FIG. 2 depicts system 200 in accordance with embodiments of the present disclosure. In one embodiment, system 200 illustrates portions of communication system 100 and omits others portions of system communication 100 to avoid unnecessarily complicating the figures and description thereof. In one embodiment, customer 202 is engaged in a communication with server 210. Server 210 utilizing data storage 212 comprises an embodiment of resource 112 when embodied as an automated resource, including but not limited to an IVR. In another embodiment, server 210 may comprise a human agent (e.g., agent 208) communicating with customer 202 and providing information to and from data storage 212 for processing by server 210.

Server 210 initially receives the communication and, in part, determines a work item to be resolved during the communication. The work item may be determined by explicit statement from customer 202, IVR inputs, etc. Additionally or alternatively, the work item may be determined, in whole or in part, via a specify entry address of contact center 102. For example, “Call 800-000-0001 for sales,” “Call 800-000-0002 for service” etc. Server 210 also obtains a time constraint for the communication. The time constraint is a time indicated or determined to be the limit for the communication, after which the communication will be terminated whether or not resolution of the work item has been achieved. The communication consumes the time constraint, for example, once the time constraint is known, from that point forward the time constraint is consumed, including the time waiting in queue, the time discussing the work item with agent 208, the time to deploy the steps to resolve the work item, etc. The resolution of the work item must be completed within the time constraint, otherwise a second communication will occur and thereby duplicate, some or all, of the resources utilized to facilitate the first, incomplete, communication.

As used herein, a work item requires resolution. If a resolution is not obtained in a first communication, a second communication occurs. As a result, some or all of the computing and networking resources utilize to establish, assess, enqueue, and route the communication are duplicated, provided resolution is obtained with the second communication. If resolution is not obtained during the second communication, a third communication is required, ad infinitum, utilizing resources until such time as a resolution is obtained.

In another embodiment, the received time constraint is utilized to select a resolution path from a number of resolution paths, as will be described more completely with respect to embodiments that follow. Communications are often enqueued to wait for an available agent, such as agent 208. Taking a communication that has a shorter time constraint before another communication, with a different customer 202, may promote resolution within the time constraint, and may be implemented. However, the embodiments herein are not directed to queue ordering, which may be provided in addition to the embodiments herein. Generally, the embodiments are directed to the variations of operations to resolve a particular work item, the variations being selected and deployed based on the time constraint.

Obtaining the time constraint is variously embodied. For example, an automated prompt provided by server 210 may cause customer communication device 108 to present a query to customer 202 that, when answered, provides the time constraint to server 210. While the temptation to artificially shorten the time constraint is present, the ability to do so may not be possible in all embodiments. For example, contact center 102 may be an internal contact center, such as a benefits department for an airline. A member of the flight crew may call the benefits department and be asked how much time they have available to resolve the work item that motivated the call. The system, such as an embodiment of server 210 with data storage 212 may comprise a scheduling application and records and know that the flight crew member has a flight leaving in thirty minutes. Accordingly, if the flight crew member states a shorter time period, for example ten minutes, server 210 may accept the time constraint as factual. In contrast, if the flight crew member just returned from a flight and has two days before their next flight, the time constraint may be processed as non-factual and ignored or discounted.

In another embodiment, server 210 may directly access a scheduling application or record, such as maintained on data storage 212 and know when customer 202, such as the flight crew member, will need to terminate the call and determine the time constraint directly from the calendaring application and/or record. If customer 202 indicates a time constraint that cannot be honored (e.g., the shortest time to resolution is greater than the time constraint), server 210 may prompt customer 202 to select a time for a call-back in order to initiate a second communication. Additionally or alternatively, server 210 and/or agent 208 may partially process the work item with the knowledge that resolution cannot be obtained, such information may be held by data storage 212 and/or other data storage to avoid duplication of resolution steps when customer 202 calls back during the second communication to complete the work item and obtain resolution. Server 210 may execute or access an artificially intelligent (AI) agent, such as a neural network and determine the time constraint without human input.

In one embodiment, customer 202 may be informed of the wait time to be connected to agent 208 (e.g., one agent of a pool of agents able to resolve the work item), before being asked to provide a time constraint. As no impact to queue order or queue wait time to be connected to an agent occurs, customers are more likely to provide reliable time constraints.

Server 210 may select a particular agent 208 from a pool of agents able to process the work item. The selected agent further comprises a service delivery attribute, such as may be maintained in a record of data storage 212. The service delivery attribute comprising at least one of an indica for expedited service, indicating the associated agent is skilled in executing a resolution that resolves the work item in a shortened timeframe, or indicia of full-service, indicating the agent is skilled in executing a resolution that resolves the work item in a normal timeframe (i.e., longer than the shortened timeframe). A full-service resolution comprises resolving the work item and satisfying at least one other objective. The at least one other objective may comprise obtaining additional information, providing additional information, performing additional operations, providing more verbose communications, etc. In contrast, expedited service comprises steps to resolve the work item and omits one or more other objectives associated with full-service resolution. For example, one objective of full-service may be to obtain verification of an early step, whereas expedited resolution omits the verification. Other differences are described in more detail with respect to the embodiments that follow.

Once customer communication device 108 and agent communication device 204 are connected as nodes in the communication, customer 202 and agent 208 may perform the steps necessary to resolve the work item. The selected agent 208 then conducts the communication in accordance with the options and/or mandated resolution path for the work item considering the time constraint. It should be appreciated that the default resolution is the full-service resolution, such as to ensure an absence of errors and optionally provide additional services determined by the contact center not essential to resolving the work item. The specific steps altered, combined, omitted, and/or truncated to provide a resolution path in accordance with the time constraint is variously embodied and may be determined as the longest resolution path available that completes prior to the time constraint.

In another option, new information may be received such that a time constraint is altered. As a result, a resolution path selected in accordance with expedited service may transition to a full-service resolution path and vice versa. Should the updated time constraint be shorter than all available resolution paths, the caller may be provided with the opportunity to discontinue the communication and establish a second communication at a later time, or to partially complete the resolution path to be completed later and continue the communication until the expiration of the time constraint.

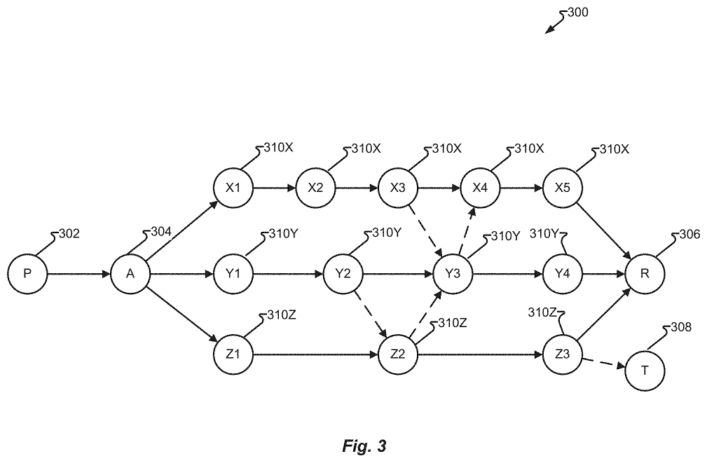

FIG. 3 depicts resolution paths 300 in accordance with embodiments of the present disclosure. Resource(s) 112 may comprise an automated resource, such as server 210 alone, a human resource, such as agent 208 alone utilizing agent communication device 204, or a combination thereof to resolve a work item. Once a work item is known, a resolution path may be selected from a number of resolution paths each of which, if processed to completion, would resolve the work item. However, a particular resolution path may be selected in accordance with the time constraint. For example, the longest (in terms of time) to get from problem node 302, wherein the work item to be resolve becomes known, to assessment node 304, wherein the time constraint becomes known, through to resolution node 306 wherein the communication is concluded successfully and the need for a second communication eliminated.

Resolution paths 300 comprise a number of nodes 310 illustrating an operation to perform to resolve the work item but not necessarily the same operation. Operations may comprise information to exchange to or from customer 202, information to exchange with another system (not shown), action to take by customer 202, action to take by agent 208, action to take by server 210, and/or other operation or combination thereof. The number of nodes 310 are illustrated as a representation of a time requirement, for example, two nodes 310 take longer to process than one node 310, but less time than three nodes 310. The letter designation provided to the nodes (i.e., “X,” “Y,” and “Z”) is provided as a means to more readily distinguish one resolution path from another. Transitioning from one resolution path to another is described with respect to embodiments that follow.

In one embodiment, a full-service path within resolution paths 300 is provided by resolution path through nodes 310X (e.g., X1, X2, X3, X4, X5). A partially expedited path is provided within resolution paths 300 through nodes 310Y (e.g., Y1, Y2, Y3, Y4), and an expedited path provided through resolution paths 300 through nodes 310Z (e.g., Z1, Z2, Z3). Nodes in full-service resolution path through nodes 310X may comprise one or more nodes that may be optional or performed off-line. For example, when resolution paths 300 are embodied to process an application for a loan, one node 310X may be to obtain income or banking information while following node 310X may be to access an external system to verify the income or banking information and a further subsequent node 310 selecting a particular loan product based on the verified income or banking information. A resolution path through nodes 310Y may similarly obtain the income or banking information and continue immediately, or more immediately, with the selection of the particular loan product with the assumption that the loan or banking information will be verified, which may be performed in a concurrent node or off-line. As a result of a resolution through nodes 310X may produce a resolution that is more accurate, having each piece of information verified, omit gathering unnecessary information, as any decision is based on a full and accurate assessment of the inputs to the decision, but take longer. A result through nodes 310Y may be comprise errors based on information gathered that is assumed to be true but later proven false and/or assumptions (e.g., borrowers like customer 202 generally want monthly payments, even though bi-monthly or weekly payments might be selected), but take less time than a resolution through nodes 310X. Similarly, a resolution through path 310Z may be more succinct, such as to perform all information gathering in one node 310 and only essential processing of the information in a subsequent node 310Z to more quickly obtain a resolution. The resolution occurring when resolution node 306 is encountered in any resolution path.

In another embodiment, one or more nodes 310 may comprise a specific methodology to perform an operation. For example, one of nodes 310X may be more verbose, compared to a similar node 310Y or 310Z. As further option, a particular resolution may permit or deny operations. For example, a node 310X may comprise an operation where agent 208 seeks an available underwriter to connect to the communication as an additional resource 112, the underwriter then obtaining or providing information in a different node 310X. In a node 310Y such an operation may be optional, providing agent 208 the selective ability to, or not to, seek an underwriter, such as if one may be joined to the call within a previously determine period of time. As a further option, a node 310X may utilize a default value and actively prevent agent communication device 204 from performing the operation of obtaining an underwriter on the communication. Other operations that may be actively prevented from occurring may include other operations that are superfluous or time-intensive (e.g., unrestrained browsing of a knowledge base by agent 208, consultation with other resources 112, etc.)

If a communication cannot reach resolution node 306 prior to the end of the time constraint, termination node 308 may be reached, such as through resolution path comprising nodes 310Z and/or other resolution path. Termination node 308 may perform any pre-termination tasks, such as schedule a call-back, provide a reference to a resolution-in-progress, and/or other operation to reduce at least a portion of the duplicative steps to resolve the work item during a subsequent communication.

A communication may have a time constraint that is static throughout the communication. However, in another embodiment, the time constraint may change to become shorter, such as when a full-service resolution through nodes 310X will no longer result in reaching resolution node 306 prior to expiration of the modified time constraint. Similarly, the opposite may occur wherein a time constraint is associated with an expedited resolution path, such as through nodes 310Y or 310Z, but subsequent modification to the time constraint allows for transitioning to a full-service path, such as from nodes 310Z to 310Y and/or from nodes 310Y to 310X, as illustrated by dashed pathways. If customer 202 provides the time constraint and inserts tangential content into the communication, server 210 may determine the time constraint to be in error and transition to a full-service resolution through nodes 310X.

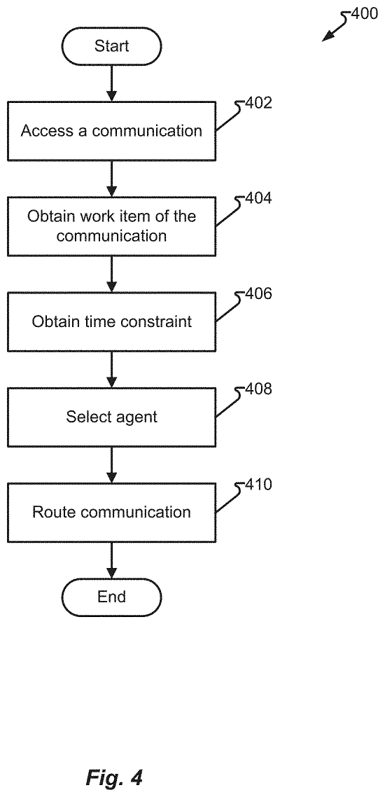

FIG. 4 depicts process 400 in accordance with embodiments of the present disclosure. In one embodiment, process 400 may be embodied as machine-readable instructions that when read by a machine, such as a processor of server 210, cause the machine to perform the steps of process 400. Process 400 begins and a communication is accessed in step 402. The communication may be initiated by customer 202 utilizing customer communication device 108 or alternatively, by server 210 and/or agent communication device 204 to customer communication device 108. If not already known, step 404 obtains the work item to be resolved during the communication and step 406 obtains a time constraint that, upon the expiration of the time constraint, causes the communication to be terminated without resolution and necessitating the need for a subsequent communication in order to obtain the resolution.

Step 408 selects an agent from a pool of agents having an associated attribute in agreement with the time constraint and the time to resolve the work item, such as to provide full-service or expedited service to resolve the work item prior to the expiration of the time constraint. Step 410 then routes the communication to the selected agent, such as to agent communication device 204 utilized by agent 208. The communication then comprises steps to resolve the work item until process 400 ends the communication terminates. The steps utilized may be nodes of a resolution path similarly selected in accordance with the time constraint the time to resolve the work item (see FIG. 3).

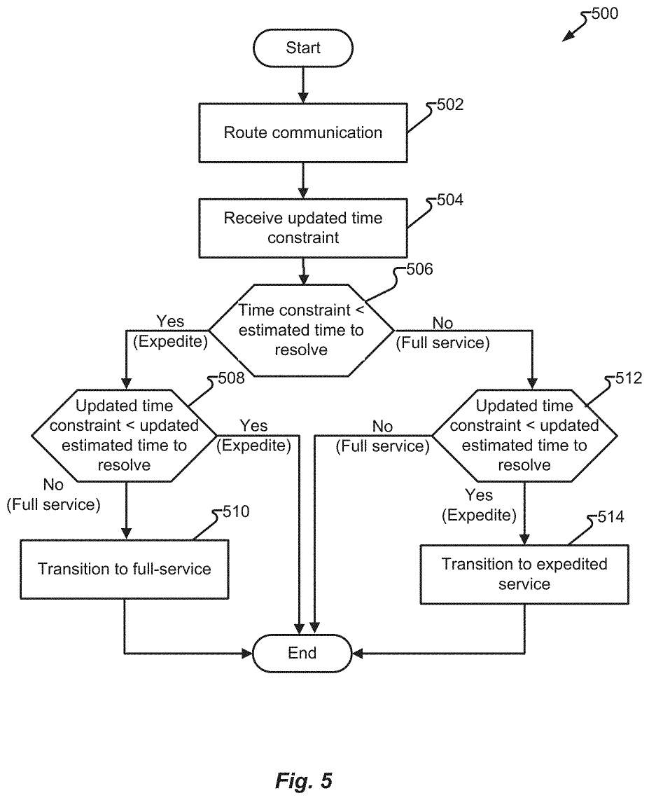

FIG. 5 depicts process 500 in accordance with embodiments of the present disclosure. In one embodiment, process 500 may be embodied as machine-readable instructions that when read by a machine, such as a processor of server 210, cause the machine to perform the steps of process 500. Process 500 begins and the communication is routed to a selected agent in step 502. During the communication, step 504 receives an updated time constraint. The updated time constraint may be provided by a node in the communication, such as customer communication device 108, and/or other system, such an update to a calendaring application or record of server 210 and/or data storage 212. As a result, test 506 determines if the original time constraint is less than the time to resolve the work item, in other words, is the resolution selected already an expedited resolution. If test 506 is determined in the affirmative, then processing continues to test 508, which further determines if the updated time constraint is less than the updated time to resolve the work item and, if determined in the affirmative, the resolution is maintained as an expedited resolution. If test 508 is determined in the negative, the resolution may be transitioned to a full-service resolution in step 510. For example, a resolution path that comprises nodes 310Z may transition to include nodes 310Y and/or nodes 310X (see FIG. 3)

If test 506 is determined in the negative, that is, the current resolution path is a full-service resolution, then test 512 further determines if the updated time constraint is less than the updated time to resolve the work item. If test 512 is determined in the negative, then the resolution is maintained as a full-service resolution. If test 512 is determined in the affirmative, the resolution is transitioned to an expedited service in step 514. For example, a resolution path that comprises nodes 310X may transition to include one or more nodes 310Y and/or 310Z (see, FIG. 3).

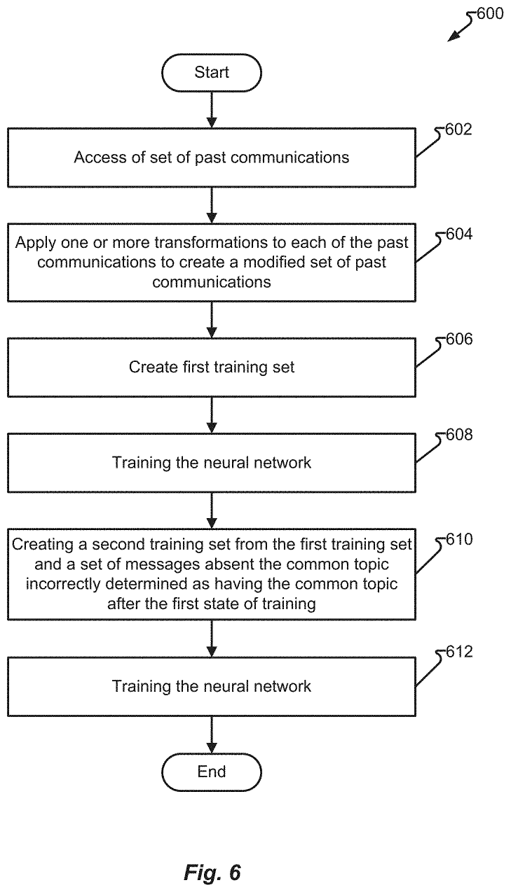

FIG. 6 depicts process 600 in accordance with embodiments of the present disclosure. In one embodiment, process 600 may be embodied as machine-readable instructions that when read by a machine, such as a processor of server 210, cause the machine to perform the steps of process 600. While systems and methods herein may obtain the time constraint from the communication comprising customer 202 and/or other system (e.g., calendar record maintained in data storage 212), in another embodiment, the time constraint may be determined via a signal from a neural network trained to determine the time constraint, such as via execution of process 600.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

In one embodiment, process 600 begins and step 602 accesses a set of past communications comprising a corresponding set of customers 202 having been engaged on each of the set of past communications to resolve a work item and a time to resolve the work item. Step 604 applies one or more transformations to the set of past communications to create a modified set of past communications, the modifications including substituting a word with a synonymous word, substituting a word with a synonymous phrase, substituting a purpose of the communication for an object associated with the purpose, substituting the object associated with the purpose of the communication with a purpose, inserting at least one redundant word, or removing at least one redundant word, altering a time of day of the communication, altering a day of the week of the communication, altering a calendar date of the communication.

Next, step 606 creates a first training set comprising the set of past communications, the modified set of past communications, and at least one of a set of past communications determined to have a time constraint less than the resolution time for the associated work item and a time for the past communication greater than the time constraint or a time constraint greater than the resolution time for the associated work item where the communication was terminated prior to resolution. Step 608 trains the neural network in a first training stage utilizing the first training set.

Step 610 creates a second training set for a second stage of training comprising the first training set and the set of communications that the time for resolution of the work item was identified erroneously in the first state. Step 612 trains the neural network in the second training stage using the second training set. The neural network may then be provided with one or more attributes of the communication and receive therefrom the time constraint. The one or more attributes may comprise one or more of past history with the particular customer 202, time of day, day of week, day of year, location of customer 202, record in data storage 212, external data source (not shown), work item, employer, demographic group, work team, etc.

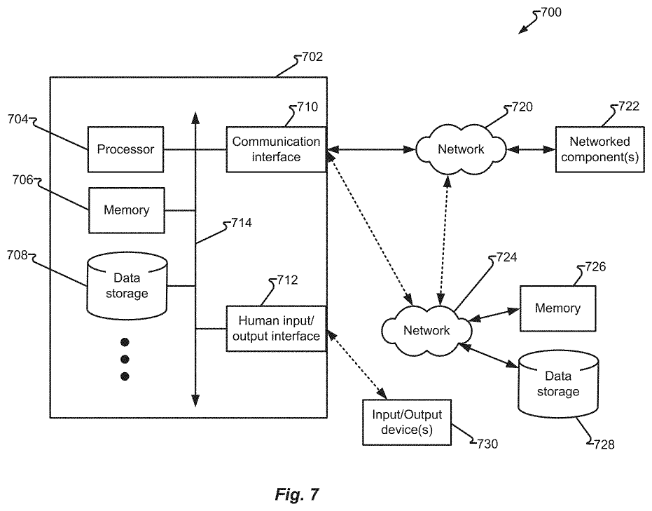

FIG. 7 depicts device 702 in system 700 in accordance with embodiments of the present disclosure. In one embodiment, server 210 and/or agent communication device 204 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or utilize one or more networks, such as network 720 and/or network 724.

Communication network 104 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.)

Additionally or alternatively, one or more other networks may be utilized. For example, network 724 may represent a second network, which may facilitate communication with components utilized by device 702. For example, network 724 may be an internal network to a business entity or other organization, such as contact center 102, whereby components are trusted (or at least more so) that networked components 722, which may be connected to network 720 comprising a public network (e.g., Internet) that may not be as trusted.

Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of memory 706, data storage 708, memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular customer communication device 108, may be enabled (or disabled) with a particular networked component 722 and/or particular resource 112. Similarly, one particular networked component 722 and/or resource 112 may be enabled (or disabled) from communicating with a particular other networked component 722 and/or resource 112, including, in certain embodiments, device 702 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22nm Ivy Bridge, the AMD® FXTM family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network; and
a processor with machine-readable instructions that when read by the processor cause the processor to perform:
accessing a communication comprising a customer device utilized by a customer for communicating with the system via the network;
accessing a work item from the customer device that will be resolved during the communication as a prerequisite to successfully closing the work item;
obtaining a time constraint, upon the expiration of the time constraint will cause the communication to be terminated;
selecting an agent, from a pool of agents, that has a skill associated with expedited resolution of the work item, when the time constraint is less than an estimated time to resolve the work item, and selecting the agent, from the pool of agents, that has a skill associated with full-service resolution of the work item, when the time constraint, is not less than the estimated time to resolve the work item; and
routing the communication to include an agent device, utilized by the agent.

2. The system of claim 1, wherein the processor receives a subsequent communication to resolve the work item, during the subsequent communication, upon the termination of the communication absent resolution.

3. The system of claim 1, wherein obtaining the time constraint comprises obtaining the time constraint from a data record comprising calendar events of the customer.

4. The system of claim 1, wherein the processor further performs:
receives an updated time constraint;
selects a transition resolution path in accordance with the updated time constraint; and
delivering the transition resolution to the agent device for execution.

5. The system of claim 4, wherein the processor further performs selecting the transition resolution path comprising the set of resolution paths associated with expedited resolution of the work item, that have been executed and the set of resolution paths associated with full-service resolution of the work item, that have not been executed and delivering the transition resolution path to the agent device for execution, when the update to the time constraint is greater than the estimated time to resolve the work item.

6. The system of claim 4, wherein the processor further performs selecting the transition resolution path comprising the set of resolution paths associated with full-service resolution of the work item, that have been executed and the set of resolution paths associated with expedited resolution of the work item, that have not been executed and delivering the transition resolution path to the agent device for execution, when the update to the time constraint is not greater than the estimated time to resolve the work item.

7. The system of claim 4, wherein the processor receives the updated time constraint upon the communication extending beyond the time constraint.

8. The system of claim 4, wherein the processor receives the updated time constraint upon the processor determining the communication comprises content tangential to the work item that is provided by the customer.

9. The system of claim 1, wherein the processor obtains the time constraint from a neural network trained to receive attributes of the communication and respond with the time constraint.

10. The system of claim 9, wherein the neural network is trained to determine the time constraint, further comprising:
accessing a set of past communications between a number of previous customers and a corresponding number of previous agents, and having an associated work item;
applying one or more transformations to each past communication of the set of past communications including one or more of substituting a word with a synonymous word, substituting a word with a synonymous phrase, substituting a purpose of the communication for an object associated with the purpose, substituting the object associated with the purpose of the communication with a purpose, inserting at least one redundant word, or removing at least one redundant word, altering a time of day of the communication, altering a day of the week of the communication, altering a calendar date of the communication, to create a modified set of past communications;
creating a first training set comprising the set of past communications, the modified set of past communications, and at least one of a set of past communications determined to have a time constraint less than the resolution time for the associated work item and a time for the past communication greater than the time constraint or a time constraint greater than the resolution time for the associated work item where the communication was terminated prior to resolution;
training the neural network in a first state using the first training set;
creating a second training set for a second state of training comprising the first training set and the set of communications that the time for resolution was identified erroneously in the first state; and
training the neural network in the second state using the second training set.

11. The system of claim 1, wherein the agent is blocked from performing at least one operation of the agent device, when the time constraint is not less than the estimated time to resolve the work item, that is not blocked when the time constraint is less than the estimated time to resolve the work item.

12. The system of claim 1, wherein the processor performs routing the communication to include the agent device, further comprising:
generating a Session Initiation Protocol (SIP) INVITE messages comprising a CUSTOM header having a value indicating the contents of the CUSTOM header include indicia of the time constraint and the time constraint; and
forwarding the INVITE message to the agent device.

13. A system, comprising:
a network interface to a network; and
a processor with machine-readable instructions that when read by the processor cause the processor to perform:
accessing a communication comprising a customer device utilized by a customer for communicating with the system via the network;
accessing a work item from the customer device that will be resolved during the communication as a prerequisite to successfully closing the work item;
obtaining a time constraint from the customer device that, upon the expiration of the time constraint will cause the communication to be terminated;
selecting a resolution path from a set of resolution paths associated with expedited resolution of the work item, when the time constraint is less than an estimated time to resolve the work item, and selecting the resolution path, from the pool of resolution paths, that is associated with full-service resolution of the work item, when the time constraint, is not less than the estimated time to resolve the work item;
routing the communication to include an agent device, utilized by an agent; and
providing the resolution path to the agent device for execution.

14. The system of claim 13, wherein the resolution path associated with full-service resolution comprises at least one verification step following an instruction, absent from the resolution path associated with expedited resolution.

15. The system of claim 13, wherein obtaining the time constraint comprises obtaining the time constraint from a data record comprising calendar events of the customer.

16. The system of claim 13, wherein the processor further performs selecting the agent, from a pool of agents, that has a skill associated with expedited resolution of the work item, when the time constraint is less than an estimated time to resolve the work item, and selecting the agent, from the pool of agents, that has a skill associated with full-service resolution of the work item, when the time constraint, is not less than the estimated time to resolve the work item.

17. The system of claim 13, wherein the processor further performs:
receives an updated time constraint;
selects a transition resolution path in accordance with the updated time constraint; and
delivering the transition resolution to the agent device for execution.

18. The system of claim 17, wherein the processor further performs;
selecting the transition resolution path comprising the set of resolution paths associated with expedited resolution of the work item, that have been executed and the set of resolution paths associated with full-service resolution of the work item, that have not been executed and delivering the transition resolution path to the agent device for execution, when the update to the time constraint is greater than the estimated time to resolve the work item; and
selecting the transition resolution path comprising the set of resolution paths associated with full-service resolution of the work item, that have been executed and the set of resolution paths associated with expedited resolution of the work item, that have not been executed and delivering the transition resolution path to the agent device for execution, when the update to the time constraint is not greater than the estimated time to resolve the work item.

19. A method, comprising:
accessing a communication comprising a customer device utilized by a customer for communicating with the system via a network;
accessing a work item from the customer device that will be resolved during the communication as a prerequisite to successfully closing the work item;
obtaining a time constraint, upon the expiration of the time constraint will cause the communication to be terminated;
selecting an agent, from a pool of agents, that has a skill associated with expedited resolution of the work item, when the time constraint is less than an estimated time to resolve the work item, and selecting the agent, from the pool of agents, that has a skill associated with full-service resolution of the work item, when the time constraint, is not less than the estimated time to resolve the work item; and
routing the communication to include an agent device, utilized by the agent.

20. The method of claim 19, wherein obtaining the time constraint further comprises obtaining the time constraint from a data record comprising calendar events of the customer.
